(19) United States
(12) Patent Application Publication
(10) Pub. No.: US 2024/0094373 A1
(43) Pub. Date: Mar. 21, 2024

(54) UNOBTRUSIVE OCCUPANCY SENSING USING RADAR-BASED SENSOR AND RIEMANN INTEGRAL AND BAND POWER APPROACHES

(71) Applicants: Amy Diane Droitcour, Lafayette, CO (US); Shekh M. M. Islam, Dhaka (BD); Chenyan Song, Honolulu, HI (US)

(72) Inventors: Amy Diane Droitcour, Lafayette, CO (US); Shekh M. M. Islam, Dhaka (BD); Chenyan Song, Honolulu, HI (US)

(73) Assignee: Adnoviv Inc., Honolulu, HI (US)

(21) Appl. No.: 18/244,374

(22) Filed: Sep. 11, 2023

Related U.S. Application Data
(60) Provisional application No. 63/375,079, filed on Sep. 9, 2022.
(60) Provisional application No. 63/481,858, filed on Jan. 27, 2023.

(51) Int. Cl. G01S 13/56; G01S 7/41

(52) U.S. Cl. CPC G01S 13/56; G01S 7/415; G01S 13/536

(57) ABSTRACT

A method and system determine the occupancy status of a room. A computer processor in the system receives a return signal from a RADAR signal emitted into the room. A baseband signal is divided into windows of time. The windows are into an overlapping arrangement wherein some data samples in at least one window are shared by data samples in another window. The data samples in the shifted windows are processed. An output value of the processed data samples is compared to a threshold value. The computer processor determines whether the room is occupied in the event the output value of the processed data samples is greater than or equal to the threshold value. The computer processor determines whether the room is vacant in the event the output value of the processed data samples is less than the threshold value.

### CROSS-REFERENCE TO RELATED APPLICATIONS

This application claims benefit under 35 U.S.C. § 119(e) of U.S. Provisional applications having Ser. No. 63/375,079 filed Sep. 9, 2022, and Ser. No. 63/481,858 filed Jan. 27, 2023, which are hereby incorporated by reference herein in its entirety.

### BACKGROUND

The embodiments herein relate generally to detection systems, and more particularly, to unobtrusive occupancy sensing and occupant count detection using radar-based sensor and Riemann integral and band power approaches.

An occupant-centric approach to building management requires sensing how occupants use and interact with their environment and using that data to proactively adjust the environment to improve occupant comfort, optimize space utilization, and reduce energy consumption. Wearable sensors that measure skin temperature, perspiration rate, and heart rate have been proposed to provide information on vital signs and changes in vital signs to provide data about human responses to enable more effective human building interactions. Wearable sensors rely on occupants using the devices and opting to share that data with the building management system, which would therefore capture the response of only a small subset of occupants. Non-intrusive infrared thermography and optical imaging have been proposed as alternative non-contact methods to evaluate thermal comfort. These methods provide an indirect assessment of skin temperature, which is a limited measure of overall physiological response to the built environment. Real-time visual perception using human eye pupil size measurements has been proposed to evaluate human response to lighting parameters. However, pupil size measurement requires interaction with a computer screen and does not provide feedback on other parameters. Innovative sensing, data analytics, algorithms, and tools are required to make Human Building Interaction (HBI) a reality. It remains a challenge to estimate the comfort and response of all occupants unobtrusively and ubiquitously.

Occupancy and vital signs sensors can be used to create healthy occupant experiences and provide sustainable solutions for the built environment. Following COVID shutdowns, people returned to offices with more awareness of the importance of environmental conditions to employee health and productivity. Companies are more aware of the potential cost savings from reduction in real-estate footprint, which can be facilitated by room-level occupancy data. Employees need positive workplace experiences and respectful safety and security to be happy and productive in working and collaborating in offices; buildings that sense occupant needs and proactively adjust lighting and ventilation can meet those demands. Occupancy sensors can provide HBI systems with data required to optimize space utilization. Occupant vital signs and changes in these parameters can provide information about wellness and comfort of occupants. Using these two pieces of data together can enable proactive adjustment of lighting, temperature, and ventilation to maintain occupant wellness, comfort, and productivity while reducing energy consumption.

Physiological sensing with Doppler radar could be used to remotely evaluate occupant response to environmental conditions, which could lead to major changes in HBI. Dedicated radar systems and wireless infrastructure-based systems have been effectively demonstrated for remote sensing of physiological parameters from distances of several meters to tens of meters with a high degree of accuracy in controlled settings. These physiological parameters include heart and respiratory rates, respiratory tidal volume, heart rate variability (HRV), and pulse pressure, as well as activity level and body orientation. Non-contact Doppler radar sensors preserve occupant privacy and are not typically noticed by the occupant.

It should be noted that residential and commercial buildings account for 40% of the total amount of energy used worldwide. Globally 28% of CO₂ emissions are caused by buildings, mostly from climate control (e.g., powering lighting, heating, and cooling). The key to eliminating waste in climate control systems is to provide heating, cooling, ventilation, and lighting only when, where, and as much as they are needed, and this requires high-resolution occupancy information. Demand-controlled ventilation (DCV) systems provide the appropriate amount of ventilation based on the estimated number of occupants in each room or zone rather than ventilating at a rate set for the maximum occupancy but are not broadly implemented because of the lack of a cost-effective, privacy-preserving, low-lag, accurate occupant count sensor.

Common motion-sensing occupancy sensors which use passive infrared (PIR) or ultrasound to control lighting are prone to error, especially when occupants are sedentary. PIR sensors can produce false alarms when warm air is injected into the environment by the air conditioning system as they measure changes in environmental heat. Ultrasound sensors can be erroneously triggered by a swinging window or curtain which can cause compression and expansion of air molecules in the room. Therefore, more reliable forms of detecting occupancy are sought. Camera-based sensing systems are an effective solution for reliably counting occupants; however, they introduce a major privacy issue as most people do not feel comfortable being monitored by a video camera. Doorway sensor systems are not always accurate at determining whether people are entering or leaving and thus can miscount the number of occupants, and their errors can accumulate over time.

Currently, carbon dioxide (CO₂) sensors are the most used method of estimating room occupant count, assuming that the rate of CO₂ generation indoors is proportional to the number of occupants. However, the CO₂-based DCV market has grown very slowly since 1990. Studies have indicated that there are numerous issues with using CO₂ sensors for ventilation control that need to be addressed, including the accuracy of the sensors, maintenance/calibration requirements, and the sensor lag times.

Advanced occupant counting sensors that provide an instantaneous, accurate estimate of the number of people present in a room can enable DCV systems to meet their true potential for energy savings and reliability. Technologies currently available and in development include computer vision systems, doorway sensors using different technologies to detect persons entering or leaving a room, sensors integrated into floor tiles, arrays of time-of-flight sensors in ceiling tiles, and analysis of reflections from Wi-Fi signals. Many people are uncomfortable with the privacy risks of ubiquitous video-based sensors, even if they are designed not to record any images, and this has slowed the uptake of these sensors. Doorway sensors are not always accurate at determining whether people are entering or leaving, or mis-count people passing through doorways side-by-side, and errors in count accumulate through the day; they are suitable for determining the flow of people in space but insufficiently accurate for broad use in DCV systems. Systems that require arrays of sensors in the floor or ceiling are expensive and complicated to install, especially in retrofit applications. Received signal strength (RSS) of Wi-Fi signals has been used to measure the number of occupants; however, this method is not accurate if one occupant blocks the sensor's line of sight to another occupant. New technologies and algorithms are necessary to accurately determine occupant number while protecting privacy, at a reasonable installation cost.

Radar technology is gaining attention for HVAC control sensing and has already proven its efficacy in remote monitoring of vital signs such as breathing rate and heart rate. Prior research demonstrated the feasibility of using radar for the reliable detection of both stationary and moving humans. Moreover, radar occupancy sensors avoid the privacy issues and lighting requirements associated with cameras. Most research towards human localization, tracking, and occupancy estimation have used frequency-modulated continuous wave (FMCW) radar as it can readily detect the range of a target, and through multiple-input multiple-output (MIMO) architecture can be exploited to estimate the angular location of the target. Prior research showed that FMCW radar range-Doppler and micro-Doppler detection capabilities can be used for the design of an efficient HVAC control sensing system. Recently, Continuous Wave (CW) Doppler radar has been investigated for use in occupancy sensing as it has a simple architecture and imposes less signal processing computational burden than FMCW radar systems. Additionally, CW radar has been investigated for estimating the number of occupants in classroom settings using the relative signal strength (RSS) method. The RSS method is dependent on the propagation environment which limits its efficacy in realistic settings. Most radar occupancy research literature is focused on the stand-alone estimation of the number of occupants present in a room environment, without consideration of occupant entry and exit events. While entry/exit events can be measured through supplemental sensors dedicated to this function, a means for extracting entry/exit information from existing basic radar occupancy sensors would provide a valuable asset for improving accuracy in occupancy estimation.

### SUMMARY

In one embodiment, a method of determining an occupancy status of a room is disclosed. The method includes receiving, by a computer processor, a return signal from a RADAR signal emitted into the room. The return signal is converted into a baseband signal. The baseband signal is divided into windows of time. The windows are into an overlapping arrangement wherein some data samples in at least one window are shared by data samples in another window. The data samples in the shifted windows are processed. An output value of the processed data samples is compared to a threshold value. The computer processor determines whether the room is occupied in the event the output value of the processed data samples is greater than or equal to the threshold value. The computer processor determines whether the room is vacant in the event the output value of the processed data samples is less than the threshold value.

In another embodiment, a computer program product for determining an occupancy status of a room is disclosed. The computer program product comprises a non-transitory computer readable storage medium having computer readable program code embodied therewith. The computer readable program code is configured, when executed by a processor, to receive, by a computer processor, a return signal from a RADAR signal emitted into the room. The return signal is converted into a baseband signal. The baseband signal is divided into windows of time. The windows are into an overlapping arrangement wherein some data samples in at least one window are shared by data samples in another window. The data samples in the shifted windows are processed. An output value of the processed data samples is compared to a threshold value. The computer processor determines whether the room is occupied in the event the output value of the processed data samples is greater than or equal to the threshold value. The computer processor determines whether the room is vacant in the event the output value of the processed data samples is less than the threshold value.

In another embodiment, a system for determining an occupancy status of a room is disclosed. The system includes a RADAR transceiver and a computing device. The computing device includes a processor configured to receive, by a computer processor, a return signal from a RADAR signal emitted into the room. The return signal is converted into a baseband signal. The baseband signal is divided into windows of time. The windows are into an overlapping arrangement wherein some data samples in at least one window are shared by data samples in another window. The data samples in the shifted windows are processed. An output value of the processed data samples is compared to a threshold value. The computer processor determines whether the room is occupied in the event the output value of the processed data samples is greater than or equal to the threshold value. The computer processor determines whether the room is vacant in the event the output value of the processed data samples is less than the threshold value.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a RADAR system for measuring detecting occupancy in a room, according to an embodiment.

FIG. 1A is a block diagram of a system for determining occupancy status in a room, according to an embodiment.

FIG. 2 is a flowchart of a method of determining occupancy status in a room, according to an embodiment.

FIG. 3 is a plot showing bandpower respiratory detection for a wall mounted detection system using different sizes of detection windows, consistent with embodiments.

FIG. 4 is a plot showing bandpower respiratory detection for a ceiling mounted detection system using different sizes of detection windows, consistent with embodiments.

FIG. 5 is a plot showing respiratory detection using a Reimann integration process for a wall mounted detection system using different sizes of detection windows, consistent with embodiments.

FIG. 6 is a plot showing respiratory detection using a Reimann integration process for a ceiling mounted detection system using different sizes of detection windows, consistent with embodiments.

FIG. 7 is a plot showing a comparison of detection accuracy between bandpower respiratory detection and a Reimann integration process, for wall mounted detection systems, consistent with embodiments.

FIG. 8 is a plot showing a comparison of detection accuracy between bandpower respiratory detection and a Reimann integration process, for ceiling mounted detection systems, consistent with embodiments

FIGS. 9(a), 9(b), and 9(c) is a group of plots showing data points for vacancy detection of a wall mounted sensor for an empty room, consistent with embodiments.

FIGS. 10(a), 10(b), and 10(c) is a group of plots showing data points for vacancy detection of a wall mounted sensor for an empty room, consistent with embodiments.

FIG. 11 shows a group of plots of fast Fourier transformation outputs in a simulation from one to ten occupants, consistent with embodiments.

FIGS. 12(a), 12(b), 12(c), and 12(d) are a group of plots in the form of scalograms for a subset of the numbers of occupants shown in FIG. 11.

FIGS. 13(a) and 13(b) are plots showing the mean maximum wavelet coefficient frequency and the wavelet coefficient energy for each number of occupants in a simulation, consistent with embodiments.

FIG. 14 is a diagrammatic view of a room occupied by people in a simulation experiment, consistent with embodiments.

FIG. 15 is a plot showing spectra of linearly demodulated signals for one through ten occupants, consistent with embodiments.

FIG. 16 is a group of plots in the form of scalograms for a subset of the numbers of occupants shown in FIG. 15.

FIGS. 17(a) and 17(b) are plots comparing the effective support between using the mean maximum wavelet coefficient frequency and the wavelet coefficient energy for each number of occupants in a simulation, consistent with embodiments.

FIGS. 18(a) and 18(b) are plots comparing the accuracy over different time windows when using the mean maximum wavelet coefficient frequency and the wavelet coefficient energy for each number of occupants in a simulation, consistent with embodiments.

FIGS. 19(a) and 19(b) are plots illustrating the trend between the output parameters and the number of occupants with effective supports of 8 and of 16 when using either the mean maximum wavelet coefficient frequency and the wavelet coefficient energy, consistent with embodiments.

FIG. 20 is a flowchart of a method for determining room occupancy count according to an embodiment.

FIG. 21 is a diagrammatic view of an empty room setup with a detection, consistent with embodiments.

FIGS. 22(a) and 22(b) are plots showing raw radar output and radar output of events, consistent with embodiments.

FIGS. 23(a), 23(b), and 23(c) are plots in scalogram format showing a time-frequency mapping at different events, consistent with embodiments.

FIG. 24 is a pair of box plots for two extracted maximum wavelet coefficient frequency and wavelet coefficient energy measurements, consistent with embodiments.

### DETAILED DESCRIPTION OF CERTAIN EMBODIMENTS

### Definitions

Baseband, as used herein refers to, the range of frequencies occupied by a signal that has not been modulated to higher frequencies.

In-Band, as used herein, refers to, the same band or channel used by the baseband.

Backscattered or Return Signal, as used herein refers to the signal result from objects detected by a RADAR signal.

### Apparatus and System Embodiments

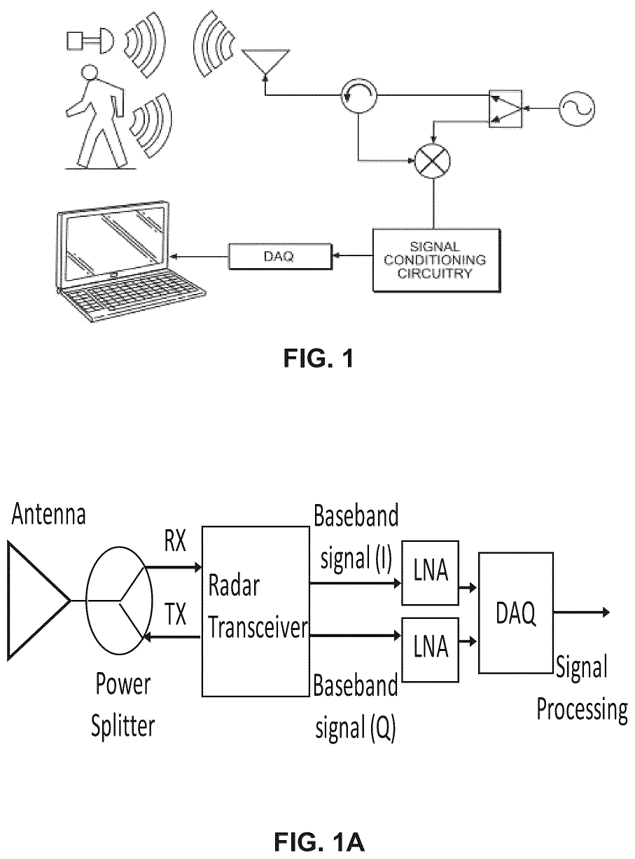

Broadly, embodiments of one subject technology include a homodyne Doppler RADAR system. Referring to FIG. 1, a RADAR system is shown according to an embodiment that may include for example, a direct conversion RADAR module with a single antenna. Embodiments of the system can be used for occupancy measurements. In this embodiment, the oscillator transmits a continuous wave 2.4 GHz signal (however, it should be understood that other frequencies may be used). The signal generator output is split between the receiver and transmitter. The transmit signal is fed into a circulator and then transmitted. The backscattered signal (sometimes referred to as the “return signal”), which is the signal that is reflected from objects (including people) in the room, is received with the same antenna, and the circulator directs the signal to the mixer for down conversion. After down conversion, filtering, and amplification the signal is digitized and processed.

FIG. 1A shows a system (similar to the system shown in FIG. 1A) for detecting the presence (occupancy) of a person in a room is shown according to an exemplary embodiment. The system may include a Doppler Radar transceiver which may be positioned in a room. The transceiver may include an antenna connected to a radio signal source, a mixer to demodulate the received signal, and a circuit configured to condition signals received by the antenna for data acquisition and subsequent analysis. In some embodiments, the “mixer” represents the RADAR transceiver. In some embodiments, the RADAR transceiver is a direct conversion radar transceiver that converts the return signal to a baseband signal. The digitized signals may be provided to a computing device which may include a processing unit configured to analyze the data for occupancy.

In an exemplary operation, the transmitter generates a radio signal and sends it to the antenna. The radio signal reflects off objects in the room and a portion of the reflected signal returns to the antenna. The signal travels from the antenna to the receiver circuitry, where it is demodulated, conditioned, and digitized. The power splitter enables a single antenna to be used for both transmitting and receiving. This helps to minimize the impact of phase noise in a direct conversion radar transceiver (that's what we are using—one that converts the signal to baseband). The digitized signal is sent to the processing unit where software processes analyze the digitized signal to determine occupancy or vacancy. The processing unit sends information about the occupancy/vacancy determination via communications and/or control circuitry such that it can be used in applications.

In an exemplary embodiment, the system may determine physiological signals from the signals received by the antenna. The occupant-related physiological signals, include for example, respiration and body movements, may be measured and recorded by the Doppler radar-based system. When there is one object moving in the room, the baseband output signal from Doppler radar can be expressed as:

$${x}_{r} ( t ) = Acos ( \frac{2 π}{λ} ( 2 {d}_{0} + 2 d ( t ) ) ) , \qquad ( 1 )$$

where λ is the wavelength of the transmitted signal, do is the static distance of radar antenna to the moving object, d(t) represents the displacement of the object over time, and A is the amplitude of the received signal. When a stationary person is breathing, d(t) represents chest displacement due to heartbeat, and respiration.

Embodiments of the hardware include a programmable microcontroller with for example, a built-in 2.4-GHz ISM band radio, a single antenna that is used for both transmitting and receiving, and signal-conditioning electronics that filter and amplify the baseband signal prior to digitization. It should be understood that the frequency band listed is only an example for a particular application and that other frequency bands may be used depending on the application. The processor can perform real-time processing, and the baseband data may be stored on removable memory (for example, memory storage cards) for subsequent processing and analysis. The radio may be programmed to operate between 2.4-2.5 GHz. The transmit power at the antenna port may be approximately 16 dBm (40 mW). An enclosure housing the radio and antenna may measure 12 cm×12 cm×10 cm, in an embodiment. The sensor may be powered via wall power with a USB adapter. In an application illustrating an example use of the subject technology, the sensor module may be mounted the ceiling in the center of a room.

Validation Testing in Smart Conference Room Testbed

The Smart Conference Room (SCR) used seats up to 23 people, has occupancy and lighting sensors, and color changeable lighting. Infrared time-of-flight sensors detect occupant location and pose (sitting, falling, standing). A mesh network of color sensors provides coarse occupancy sensing and measures reflected sunlight and solar heat flux. Over 27 hours of data has been collected with the sensor system in the SCR, covering a number of variables, which are outlined in Table 1. Data includes values from an empty room on each day that sensor was tested; with a single person sitting quietly in all the different seats at the conference table and in the corners of the room; and with a single person moving with fine motion (typing, fidgeting, or swiping on a phone), and with larger motion such as walking or gesticulating. Data has also been collected with 2-10 people sitting quietly, with fine motion, and with large motion in different positions in the room. Data has been collected in controlled settings and during regular meetings that occur in the conference room.

TABLE 1
Variables in Smart Conference Room data collection, with the amount
of time each option was used rounded to the nearest quarter hour.

| | Wall Mounting | Ceiling Mounting |
|---|---|---|
| Mounting | 4.25 hours | 22.75 hours |

| | Empty | Single Occupant | Multiple Occupants |
|---|---|---|---|
| Occupancy | 9.25 hours | 6.75 hours | 11 hours |

| | Video | Time of Flight |
|---|---|---|
| Reference | 22 hours | 6.5 hours |

| | Breathing Normally, | | |
|---|---|---|---|
| | HR not noted | Breathing in Sync | HR recorded |
| Vital Signs | 22 hours | 2.5 hours | 2.5 hours |

Microwave Doppler Radar Detection of Respiration of Multiple Occupants

A microwave Doppler radar transmits an electromagnetic signal; when the signal reflects off objects in the room, the reflected has a phase shift proportional to the motion of those objects and a magnitude proportional to the radar cross section of those objects. If a stationary person is present, the phase shift of the reflected signal is proportional to the tiny movement of the chest surface due to cardiorespiratory activity. The phase shift from an occupant can be described as:

$${θ}_{1} ( t ) ∝ \frac{4 π}{λ} {d}_{1} ( t ) , \qquad ( 2 )$$

where λ is the wavelength of the transmitted signal and d₁(t) represents a single occupant's chest displacement due to heartbeat and respiration.

Mixers used in radio and radar receivers are inherently nonlinear, and therefore generate intermodulation and harmonic responses. In Doppler radar physiological sensing of multiple stationary occupants, the fundamental tones are those proportional to chest surface motion due to cardio-respiratory activity of each occupant. The intermodulation generates signals at sums and differences of various combinations of multiples of these frequencies, effectively broadening the signal's spectrum at the mixer output.

For simplicity, in the case of two occupants, it will be described how the intermodulation term is theoretically generated. A mixer has two input ports; the reflected signals are applied to the mixer's RF port. Each reflected signal has a carrier frequency f_{c} and its phase modulated θ(t). In a continuous wave, direct conversion radar transceiver, the local oscillator (LO) is derived from the transmitted radar signal at frequency f_{c}, and is applied to the mixer's LO port. An ideal mixer would multiply the RF port signals by the LO port signal, generating sum and difference frequencies. In the case of two occupants, the ideal mixer is acting on two summed RF input signals, generating an output M_{2 occupants}(t):

$${M}_{2 occupants} ( t ) = cos ( 2 π {f}_{c} t ) * [ {A}_{1} ( t ) cos ( 2 π {f}_{c} t + \frac{2 π}{λ} ( 2 {d}_{0 , 1} + 2 {d}_{1} ( t ) ) ) + {A}_{2} ( t ) cos ( 2 π {f}_{c} t + \frac{2 π}{λ} ( 2 {d}_{0 , 2} + 2 {d}_{2} ( t ) ) ) ] = \frac{{A}_{1} ( t )}{2} [ cos [ \frac{2 π}{λ} ( 2 {d}_{0 , 1} + {d}_{1} ( t ) ) ] + cos [ 4 π {f}_{c} t + \frac{2 π}{λ} ( 2 {d}_{0 , 1} + {d}_{1} ( t ) ) ] ] + \frac{{A}_{2} ( t )}{2} [ cos [ \frac{2 π}{λ} ( 2 {d}_{d0 , 2} + {d}_{2} ( t ) ) ] + cos [ 4 π {f}_{c} t + \frac{2 π}{λ} ( 2 {d}_{0 , 2} + 2 {d}_{2} ( t ) ) ] ] , \qquad ( 3 )$$

where f_{c} is the carrier frequency, Aₙ(t) is the amplitude modulation on the signal reflected by occupant n, d_{0,n} is the distance to occupant n, and dₙ(t) is occupant n's time-varying physiological displacement. The output of the mixer consists of modulated components at the sum and difference frequencies. The sum frequency is easily rejected by a lowpass filter, leaving only the difference frequencies, which are at baseband and shown as B_{2 occupants}(t):

$${B}_{2 occupaants} = \frac{{A}_{1} ( t )}{2} [ cos [ \frac{2 π}{λ} ( 2 {d}_{0 , 1} + {d}_{1} ( t ) ) ] ] + \frac{{A}_{2} ( t )}{2} [ cos [ \frac{2 π}{λ} ( 2 {d}_{d0 , 2} + {d}_{2} ( t ) ) ] ] . \qquad ( 4 )$$

However, in practice, a mixer is a nonideal multiplier, and in addition to the sum and difference frequencies, it generates harmonics and mixing products other than the desired outputs. The use of a nonideal multiplier can be illustrated by describing the current/voltage (I/V) characteristics of the nonlinear device (the mixer) via a power series,

I=a₀+a₁V+a₂V²+a₃V³+ (5),
and letting V equal the sum of the two inputs to the mixer and I equal the mixer output current.

In the case of two breathing occupants,

$$V = cos ( 2 π {f}_{c} t ) + {A}_{1} ( t ) cos ( 2 π {f}_{c} t + \frac{2 π}{λ} ( 2 {d}_{0 , 1} ( t ) + 2 {d}_{1} ( t ) ) ) + {A}_{2} ( t ) cos ( 2 π {f}_{c} t + \frac{2 π}{λ} ( 2 {d}_{0 , 2} + 2 {d}_{2} ( t ) ) ) , \qquad ( 6 )$$

where the first term is the local oscillator, the second term is the reflection from the first occupant, and the third term is the reflection from the second occupant. When this is input to equation 4, the first term, a0, is a DC offset, and the second term, a1V, leaves the signals at the RF frequency which are typically removed by the lowpass filter. The third term, where the voltage is squared, generates a DC offset, the terms where the LO is multiplied by each input, and introduces intermodulation where the signals from the two occupants are multiplied together. With all the DC values lumped together, the baseband signal after lowpass filtering is:

$${I}_{BB , squared term} = DC + {A}_{1} ( t ) cos ( \frac{2 π}{λ} ( 2 {d}_{0 , 1} + 2 {d}_{1} ( t ) ) ) + {A}_{2} ( t ) cos ( \frac{2 π}{λ} ( 2 {d}_{0 , 2} + 2 {d}_{2} ( t ) ) ) + {A}_{1} ( t ) {A}_{2} ( t ) cos ( \frac{2 π}{λ} ( 2 {d}_{0 , 1} + 2 {d}_{1} ( t ) ) ) cos ( \frac{2 π}{λ} ( 2 {d}_{0 , 2} + 2 {d}_{2} ( t ) ) ) . \qquad ( 7 )$$

The last term is the intermodulation term

$${I}_{intermodulation} = \frac{{A}_{1} ( t ) {A}_{2} ( t )}{2} ( cis ( \frac{2 π}{λ} ( 2 {d}_{0 , 1} + 2 {d}_{0 , 2} + 2 {d}_{1} ( t ) + 2 {d}_{2} ( t ) ) ) + cos ( \frac{2 π}{λ} ( 2 {d}_{0 , 1} - 2 {d}_{0 , 2} + 2 {d}_{1} ( t ) - 2 {d}_{2} ( t ) ) ) , \qquad ( 8 )$$

where the sum and difference of the respiratory terms occur inside the cosine, spreading the output spectrum. When higher order intermodulation terms are included, the intermodulation terms get more complex, and as such are generated the simulation in the next section rather than analytically generating them here.

In radar measurement of physiological motion, the largest signal is respiration, and amplitude modulation A_{N}(t) is minimal and can be estimated as a constant Aₙ. Simplifying the phase modulation to include only the respiratory signal, and simplifying the respiratory signal to a cosine, occupant n's physiological motion can be estimated as

d(t)=cos(2πfₙt) (9),
where fₙ is occupant n's breathing frequency.

With a direct conversion radar, the DC phase shift d_{0,n} can be removed in hardware or software. It also can be assumed that the voltage of the modulated input signal is much smaller than that of the LO. With these simplifications, and after an appreciable amount of algebraic and trigonometric manipulations, when two occupants are present with breathing frequencies f₁ and f₂, the mixer output current contains small-signal components at the frequencies:

f_{a,b}=af₁+bf₂, where, a,b=0,+1,−1,+2,−2, (10).

Frequencies other than the fundamental respiratory frequencies are harmonics (where one of a or b is equal to 0 and the other is greater than 1) and intermodulation tones (where both a and b are non-zero). The order of the intermodulation is calculated by a+b. For example, if there is a presence of two subjects at a breathing rate of f₁=0.25 Hz and f₂=0.3 Hz, then a second order intermodulation tone f₁+f₂ will be at 0.55 Hz. The intermodulation products are theoretically infinite, because there are no bounds on a or b, but in practice, the amplitude of intermodulation products decreases with increasing order.

As the number of occupants increases, there are more signals that intermodulate (f₁, f₂, . . . , f_{N} with N being the number of occupants present). For example with N occupants present, intermodulation products occur at:

fₐ_{₁}_{,a}_{₂}_{,a}_{₃}_{, . . . a}_{_{N}}=a₁f₁+a₂f₂+a₃f₃+ . . . +a_{N}f_{N} where,a₁,a₂,a₃, . . . ,a_{N}=0,+1,−1,+2,−2 (11)
and the order of intermodulation is the sum of coefficients aₓ.

When more occupants are present, more high-frequency content is included in the baseband signal, and the baseband signal frequencies are spread more broadly. By analyzing the time-frequency content of the baseband signal to quantify the amount of higher frequency content and/or the degree of spectrum spreading, the number of occupants can be estimated.

Riemann Integral and Bandpower Approaches

Occupancy/Vacancy Detection Algorithms

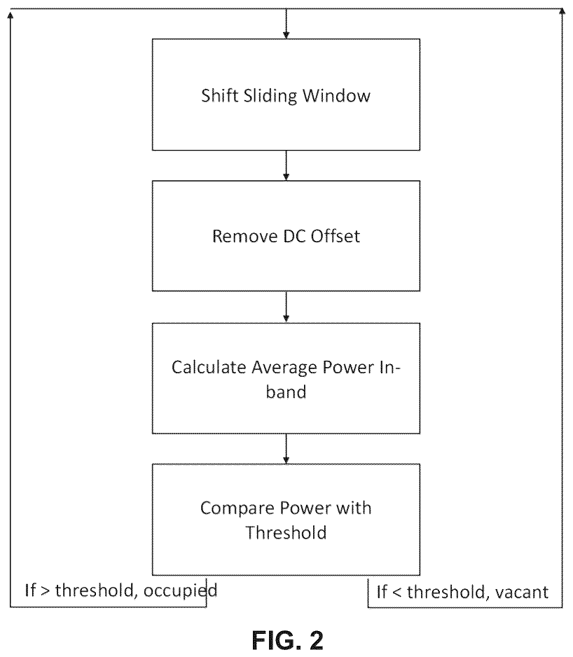

Referring now to FIG. 2, a method of determining occupancy of a room using band power is shown according to an embodiment. The data may be obtained with an empty room and with primarily stationary occupants analyzed to evaluate the detection accuracy of the sensor system. To determine the occupancy status of the conference room with the data collected via the sensor system, algorithms based on Riemann Integral (RI) and Band Power (BP) were developed. In both the RI and BP algorithms, a sliding window method may be used, i.e., the data in each recorded file of the return signal from the RADAR signal were divided into continuous windows of a specified length of time. Each window contains data samples overlapped with the previous window except the first window. When multiple people are in the room, the signal is the intermodulation of these signals. The signals detected and recorded by the sensor system contain DC offsets that are induced by reflections from static objects; these DC offsets may be removed by subtracting the mean of the raw data in each window from each sample. Since respiration signals are below 1 Hz, a low-pass filter may also be employed in each window to remove high-frequency noise. After the signals are windowed, filtered, and have their DC offset removed, these conditioned signals are analyzed with either the RI or the BP method, as described below.

RI Method

In each window, the RI process integrates all the samples and compares the result with a preset threshold. The following equation shows the calculation of RI in the k-th sliding window of the conditioned radar signal x(t) as:

RI(k)=Σₙ₌₀^{N-1}|xₖ(n)| (12),
where N denotes the total number of samples in each window. The RI in each window is compared to a pre-set threshold to determine occupancy; if the RI is above the threshold, the room is considered occupied, and if the RI is below the threshold, the room is considered vacant. The RI threshold is calculated from data recorded in an empty room as the average value plus 1.5 times the standard deviation.

BP Method

In each window, the BP algorithm calculates the average power in a specified frequency band corresponding to a typical range of respiration rates, and compares that value to a pre-set threshold. In one example, the average power may be the average of the instantaneous power of the in-band signal. The in-band signal may be produced by We are doing it by generating a periodogram power spectral density of the signal and integrating in the appropriate frequency band. This may involve for example, transforming the signal to frequency space with a discrete Fourier Transform. The in-band signal generation may also be done by filtering the signal with a very sharp band pass filter and then determining the power of the remaining signal. Typically counted as the area under the curve of the square of the signal, the average power may be found by the following equation:

P_av=1/T (integral from 0 to T of x\hat{ }2(t))dt (13).

For example, the frequency band used was 0.1 Hz-0.3 Hz, corresponding to a wide range of adult resting respiration rates of 6 to 18 breaths per minute. The average power in the specified respiratory frequency range was determined by a band power function, which applies a modified periodogram to the signal. The BP threshold may be calculated as the average power plus one standard deviation from data recorded when the room is empty. If the BP value exceeds this threshold, the room is considered occupied, and if it is below the threshold, the room is considered vacant.

Vital Signs Estimation

In this analysis, respiratory and heart rates were determined by segmenting the signal to remove sections with high amplitude (indicating large motion), and then analyzing segments that were 20 seconds long. The example segment is long enough to typically include at least three respiration cycles. To estimate respiration rate, the segmented signals were filtered with a Finite Impulse Response (FIR) bandpass filter with corner frequencies at 0.05 Hz and 1 Hz to remove out-of-band noise and DC offsets. To estimate heart rate, the segmented signals were filtered with a FIR bandpass filter with corner frequencies at 0.8 Hz and 3 Hz to remove respiration and out-of-band noise, while still digitizing the fundamental and the second harmonic of the heart signal. Adult resting heart rates are typically 50 to 90 beats per minute, or 0.83 to 1.5 Hz, so the second harmonics are at 1.67 to 3 Hz. The Fast Fourier Transform (FFT) was applied to the filtered signals to generate the signals' frequency spectra. The frequency associated with the maximum amplitude of the FFT was converted to breaths per minute to estimate the respiratory rate and to beats per minute to estimate the heart rate.

Occupancy/Vacancy Sensing

The detection accuracy of the RI and BP methods was quantified as the amount of time vacancy or occupancy was correctly detected by the sensor system using each method divided by the total time measured, converted to a percentage. The higher the percentage, the more accurate the method is. The true vacant or occupied time was determined by the video reference data for most measurements except for the cases where video was not recorded (to preserve privacy during meetings) and the LESA infrared time-of-flight sensor data were used for reference.

With the 100 Hz sampling rate of the sensor system, to achieve 0.1 Hz resolution, a minimum window size of 10 seconds or 1000 samples may be used for the BP calculation. It may be understood that the selection of the window size impacts the accuracy of the method. This may be because respiration is not a constant activity—it varies with time—and a longer window will capture more variation. After studying the impact of various window sizes on the detection accuracy of occupancy status for both BP and RI methods, a 1-minute window with 30 seconds of overlap for a wall-mounted sensor system and 2-minute window with 1-minute overlap for a ceiling mounted sensor system were determined to produce the best accuracy when using the BP method. A 1-minute window with 30 seconds overlap was optimum for both installation configurations when using the RI method.

TABLE 2
Detection Accuracy Summary of Wall-Mounted and Ceiling-Mounted Sensor

| Wall Mounted | | | | Ceiling Mounted | | | |
|---|---|---|---|---|---|---|---|
| | Test | BP | RI | | Test | BP | RI |
| | Time | Accuracy | Accuracy | | Time | Accuracy | Accuracy |
| Date | (min) | (%) | (%) | Date | (min) | (%) | (%) |
| Jun. 11, 2021 | 35 | 94.29 | 92.86 | Jul. 23, 2021 | 65 | 95.38 | 97.62 |
| Jun. 14, 2021 | 28 | 98.21 | 92.86 | Jul. 29, 2021 | 51 | 92.16 | 93.00 |
| Jun. 17, 2021 | 45 | 90.00 | 92.22 | Aug. 3, 2021 | 56 | 89.29 | 86.96 |
| Jun. 18, 2021 | 36 | 94.44 | 84.72 | Aug. 9, 2021 | 52 | 94.23 | 89.11 |
| Jun. 21, 2021 | 14 | 96.43 | 85.71 | Aug. 28, 2021 | 16 | 93.75 | 88.24 |
| Jun. 22, 2021 | 13 | 92.31 | 92.31 | Aug. 30, 2021 | 16 | 87.50 | 87.50 |
| Jun. 28, 2021 | 23 | 91.30 | 91.30 | Sep. 3, 2021 | 51 | 98.04 | 97.12 |
| Jul. 9, 2021 | 64 | 96.09 | 96.09 | | | | |
| Overall | 258 | 94.19 | 91.86 | Overall | 307 | 93.49 | 92.32 |
| STD | — | 2.64 | 3.74 | | — | 3.12 | 4.37 |

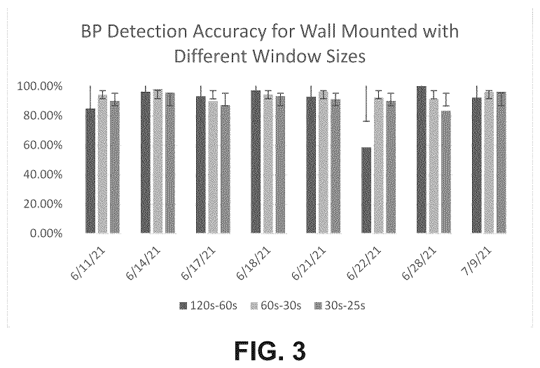

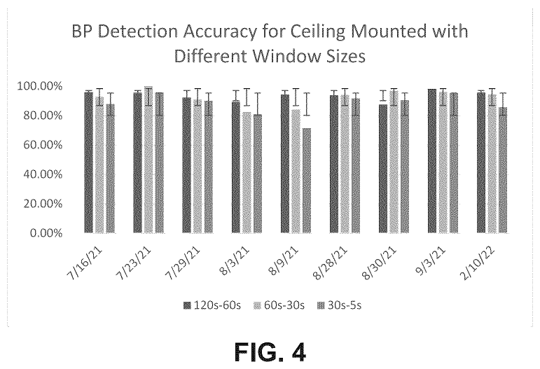

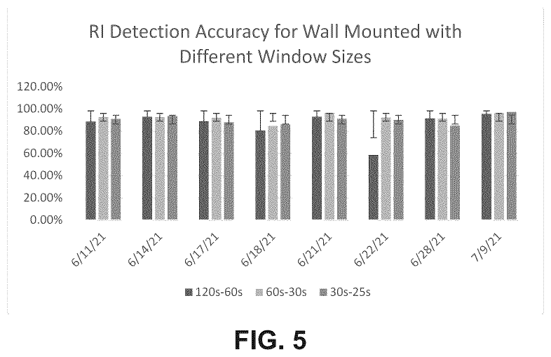

Table 2 summarizes the detection accuracies of wall-mounted and ceiling-mounted sensor systems using BP and RI methods to detect and determine the vacancy/occupancy of the room. FIGS. 2-5 show the data in plot format. To evaluate and assess the accuracy of the sensor systems and the algorithms, data were collected for a various length of time over several days. The day-by-day accuracy of the sensor systems may be determined by comparing the detection results with the video or infrared reference as described above. The overall accuracy was determined by weighted mean of the determined accuracies as shown by following equation:

$$Overall Accuracy ( \% ) = \frac{{\sum }_{i = 1}^{n} {x}_{i} \times {w}_{i}}{{\sum }_{i = 1}^{n} {w}_{i}} , , \qquad ( 14 )$$

where n is the number of testing days, wᵢ is the testing time for each day, xi is the accuracy for each day. The standard variation of the weighted mean accuracy is calculated in Equation (15) as follows:

$$STD = \sqrt{\frac{{\sum }_{i = 1}^{n} {{w}_{i} ( {x}_{i} - \overline{x} )}^{2}}{\frac{n - 1}{n} {\sum }_{i = 1}^{n} {w}_{i}}} , , \qquad ( 15 )$$

where n is the number of testing days, wᵢ is the testing time for each day, xi is the accuracy for each day, and x is the weight mean accuracy determined by equation (14).

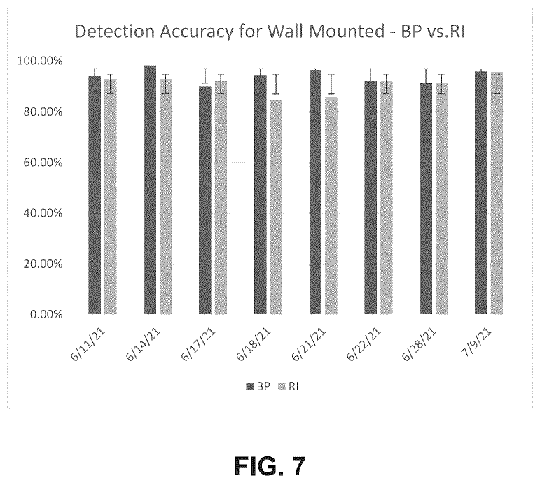

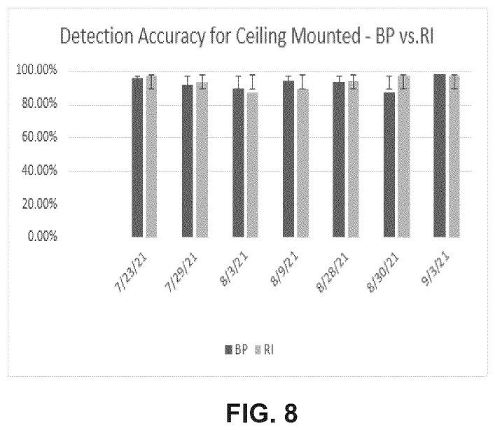

The results in Table 2 (which can also be seen in FIGS. 7 and 8) show that the sensor using the BP method can achieve day-by-day accuracies of above 87% and about 94% of overall accuracy with variation of about 3% when occupants are primarily sedentary or the room is vacant (accuracy would be higher when moving occupants are also included). This is slightly better than the RI method, which has day-by-day accuracies of above 85% and about 92% of overall accuracy with variation of about 4%. The BP method may be more accurate because it focuses on the power in the respiration frequency band, and most noise or interference is outside this band, while noise or interference can still trigger the RI threshold. This is illustrated in FIG. 2, which includes data collected when the smart conference room was empty. Damped oscillations appear in the first 4 minutes of the radar signal detected by the sensor system. Since the oscillations of the data are not within the respiration frequency range, the BP method provides 95% detection accuracy, much better than RI method which reports the room as occupied for almost half of duration of this data set.

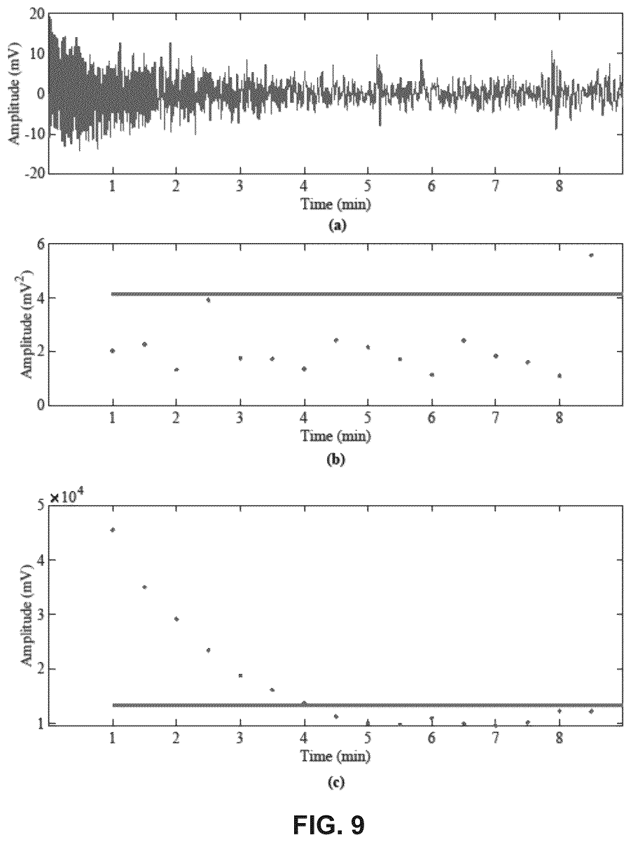

FIGS. 9(a), 9(b), and 9(c) shows data points for vacancy detection of a wall mounted sensor for an empty room, using 1-minute sliding-window with 30 seconds overlapping: 9(a) Filtered radar signals after static-background being removed still contain a lot of noise outside the respiration band; 9(b) Most of the noise is correctly discerned by BP method, which shows the room as vacant (dots below the line indicate vacancy) 9(c) RI method cannot discern the large amplitude signal in the empty room potentially caused by vibration after plugging in the sensor and it reports false occupied signals for the first 4 minute (where dots are above red line) before correctly indicating vacancy (when dots drop below the line).

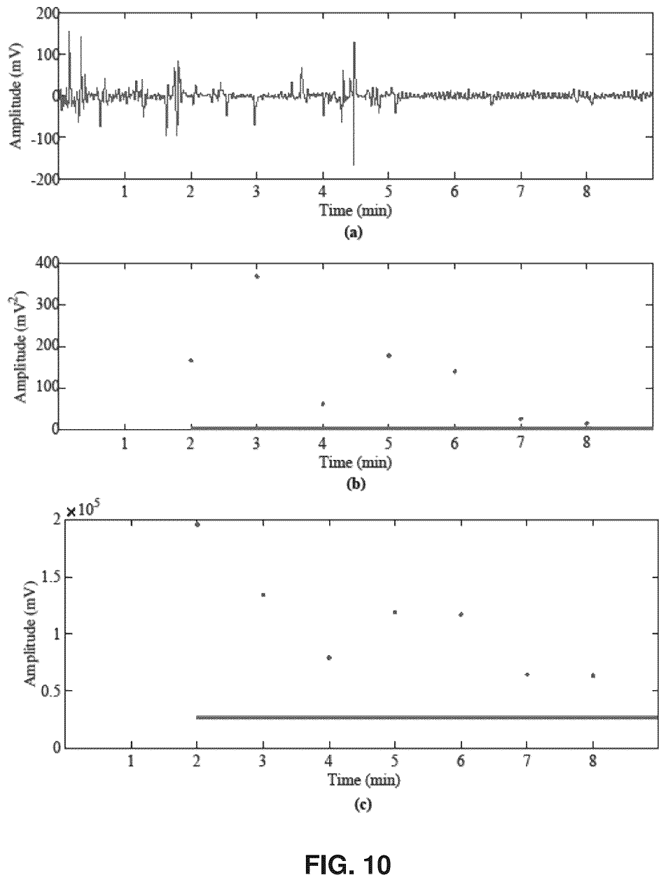

Referring now to FIGS. 10(a), 10(b), and 10(c), plots show a comparison of detection by a ceiling mounted sensor of the subject technology. In FIG. 10(a), the sensor detects a person hiding under table as represented by the filtered RADAR signals after static-background is removed. In FIG. 10(b), band power results (represented by dots) are consistently above the band power threshold (represented by the line), so occupancy was accurately detected 100% of the time using the BP algorithm. In FIG. 10(c), Riemann Integral results (dots) are consistently above the RI threshold (line), so occupancy was accurately detected 100% of the time using the RI algorithm. In this testing, a 2-minute window was updated each minute (except the first window was 2 minutes after the test started to fill the window). Both BP and RI methods determined the room is occupied when the occupant was under the table with 100% detection accuracy compared with the video reference, while the time-of-flight infrared sensor could not detect the occupant under the table.

Vital Signs Estimation

Vital signs estimation was evaluated for data in which a single occupant was sitting still and a respiratory rate and/or heart rate was known. For respiratory rate, the known rate was obtained by instructing the occupant to breathe at a consistent rate (selected by the subject) in accordance with a metronome. For heart rate, the known rate was obtained by recording the heart rate displayed on a smart watch every few minutes. If the respiratory rate obtained was within 1 breath per minute of the metronome rate, it was considered to be accurately detected. If the heart rate obtained was between the highest and lowest heart rates recorded during the measurement period, it was considered to be accurately detected.

In the initial experiments, the sensor system was mounted near the top of the wall. An occupant was breathing in accordance with a metronome at a selection of seats around the table, and in each corner of the room. For the wall-mounted sensor, respiratory rate was detected in every seat at the table at which it was measured, and in three corners of the room, including the two far corners which were over 9 m from the sensor. In the corner where respiratory rate was not detected, presence was detected from fine motion. Heart rates were not recorded while the sensor system was wall-mounted, so heart rate detection is not indicated in this figure.

In the next set of experiments, the sensor was mounted on the ceiling in the center of the room, above a table. For these experiments, an occupant sat at all seats at the table and in each corner of the room, and in various experiments, breathing was in accordance with a metronome and heart rates were recorded. With the ceiling-mounted sensor, respiratory rates were detected in all positions that were tested, and heart rate was detected at all tested locations except for one corner of the room. The corners were 5 m from the sensor, which was located on the ceiling in the center of the room.

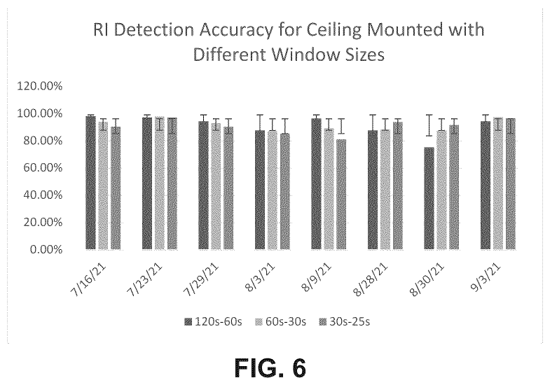

Some heart and respiration signals that were detected from occupants in different locations in the smart conference room, while the sensor system is mounted on the ceiling in the center of the room, are shown in FIG. 6. In all three shown cases, the heart rate detected via the sensor system closely matches that recorded by the occupant from a smart watch and the respiratory rate estimated by the sensor system matches the rate which the occupant chose and maintained with the help of a metronome.

The extensive testing has provided data to validate high accuracy of occupancy/vacancy detection with the sensor system in the most challenging scenario (stationary occupants vs empty room) and successful respiratory and heart rate detection for occupants in natural positions and orientations, with a single sensor, throughout a 3.5×8.5 m conference room. When the sensor was ceiling-mounted, presence was detected from occupants that were completely stationary (other than respiratory motion) in all locations in the room, including under the table, with accuracy of 93% using short one-to-two-minute windows. Respiratory rates were detectable in all room locations, and heart rate was detectable when the occupant sat at each seat at the conference table and three corners of the room. This is the first demonstration of a highly accurate occupancy/vacancy sensor that also provides physiological parameters.

Entry Exit and Count Method

In another technology of the subject disclosure, a single radar-based motion sensor with wavelet-based algorithms may be used to detect entry and exit events to count occupants, and when all occupants are stationary, can estimate the number of occupants in a room, correcting any errors in count from entry/exit events. This technology can potentially be used to optimize real estate utilization and ventilation rate in DCV HVAC systems, reducing real estate and energy costs while keeping occupants productive and comfortable. Radar-based sensors of the instant technology may provide occupant count without the errors introduced by doorway sensors, without the delays and inaccuracies of CO₂ sensors, without the privacy issues introduced by video-based sensors, and without the high up-front cost of systems that require a dense array of sensors.

In one embodiment, wavelet time-frequency analysis using the Morlet wavelet transform and maximum wavelet coefficient frequency (MWCF) and wavelet coefficient energy (WCE) is proposed for occupant estimation. In other embodiments, other wavelets and/or other approaches to time-frequency analysis may be used, including entropy of the wavelet coefficients. A comprehensive simulation and experimental results demonstrate that MWCF and WCE parameters increase monotonically with the number of occupants. Data analysis with varying wavelet effective support and Doppler RADAR data window size demonstrate robustness and potential for near real-time implementation of this approach.

The following disclosure focuses on leveraging data from a single-antenna continuous wave RADAR occupant presence detection system for the detection of occupant entry and exit events. Aspects of the system better track occupant traffic and improve the accuracy of occupant count estimation. The experimental assessment confirms that the time-frequency content of a RADAR signal can be analyzed using a wavelet transform (WT) to extract both maximum wavelet coefficient frequency (MWCF) and wavelet coefficient energy (WCE) to produce discernably different results for entry and exit events. The proposed system and signal processing method thus have the potential for enhancing the function of basic radar occupancy sensors to provide detailed information on occupant traffic and count, which are essential in applications including building management, energy conservation, and security.

To better understand the time-frequency content caused by intermodulation of signals from a radar sensor detecting breathing from multiple occupants, a simulation may be developed. For each simulation run, ten sinusoidal signals were generated at different frequencies within the range of the respiration signals (random values uniformly distributed from 0.2-0.3 Hz), with respiratory amplitude randomized from 0.01 to 0.03 meters peak to peak. A radio frequency signal (RF) and local oscillator signal (LO) were generated, each as a sinusoidal tone. Because each occupant in a room reflects an RF signal with its phase modulated at the respiratory frequency, a reflected RF signal was generated for each simulated occupant. The simulated received RF signal was the original radio frequency (RF) signal with amplitude randomized from 0.2 to 2, with the phase of the signal having an offset randomized from 0 to 2π and an additional phase component with a cosine at the simulated respiratory frequency and amplitude. To simulate a realistic mixer (with nonlinear characteristics) operating on the RF and LO signals, the combined RF signal was summed with the LO and the combined signal was input into a trinomial equation y=a1x+a2×2+a3×3. Coefficients used were a1=1, a2=1, and a3=0.41, chosen to simulate a passive diode mixer. The output signals were filtered with a 100-order 25-Hz lowpass FIR filter for anti-aliasing and then downsampled to 100 Hz.

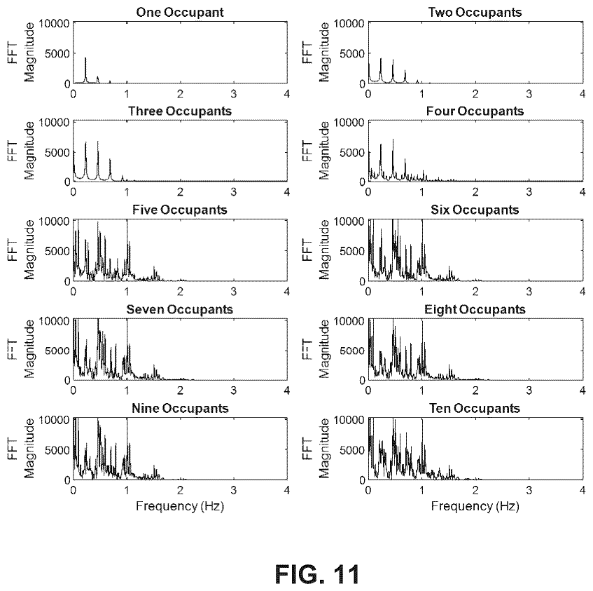

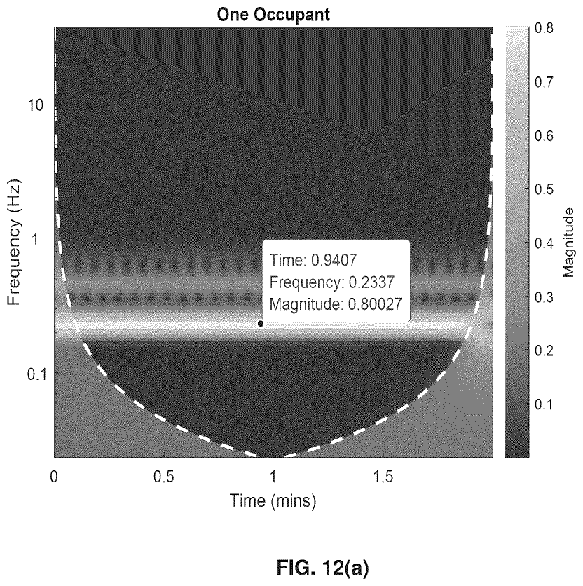

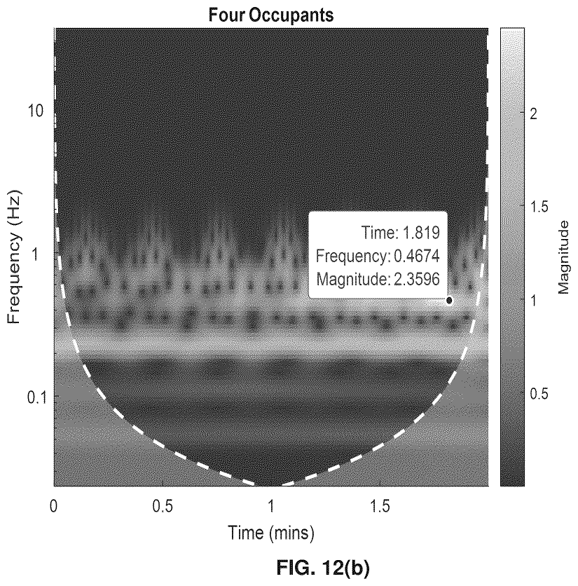

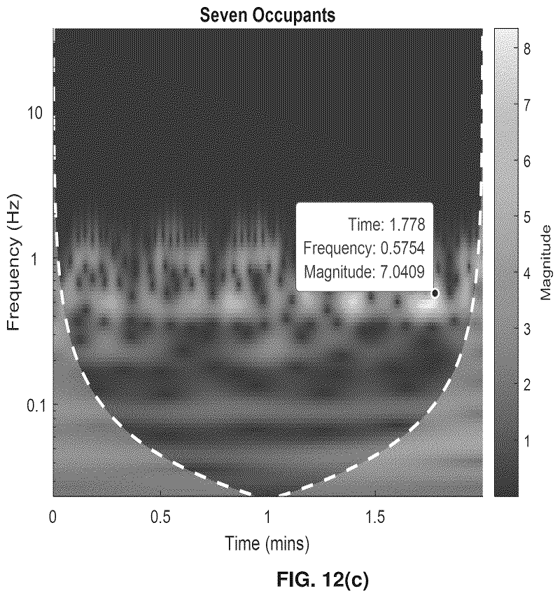

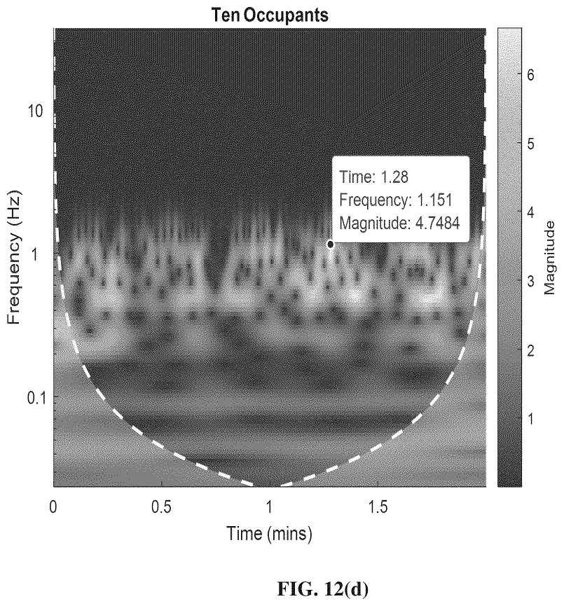

A fast Fourier transform (FFT) may be performed and a wavelet transform (WT) using the Morlet wavelet may be performed with an effective support of 16 (−8 to 8) of output signals to extract the time-frequency information. FIG. 11 illustrates an example of the FFT outputs in a simulation from one to ten occupants, and the scalograms for a subset of the numbers of occupants is shown in FIGS. 12(a), 12(b), 12(c), and 12(d), both from a simulated case where the 10 randomly generated frequencies were: 0.2272 Hz, 0.2291 Hz, 0.2290 Hz, 0.2839 Hz, 0.2742 Hz, 0.2424 Hz, 0.2343 Hz, 0.2203 Hz, 0.2006 Hz, and 0.2493 Hz. The FFT for a single occupant shows the fundamental breathing signal and its harmonics. For increasing numbers of occupants, the spectrum broadens and there is frequency content at frequencies other than the fundamental signals and harmonics from each occupant; this is showing the effects of intermodulation. In FIG. 11, the maximum values in the scalogram are highlighted—these indicate the maximum wavelet coefficient, and the frequency associated with this coefficient is the MWCF (maximum wavelet coefficient frequency). This value increases with the number of occupants present with values of 0.23 Hz for one occupant, 0.46 Hz for 4 occupants, 0.58 Hz for 7 occupants, and 1.2 Hz for 10 occupants.

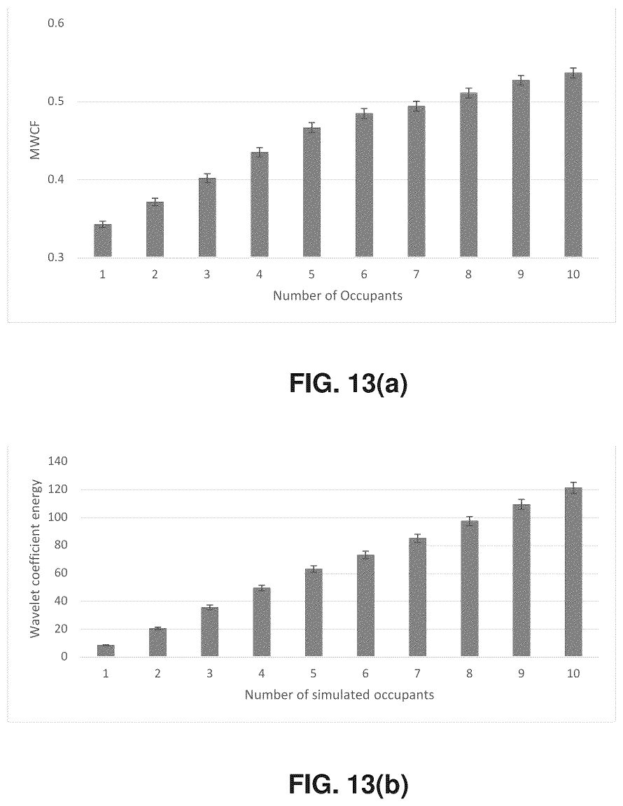

FIGS. 13(a) and 13(b) show the mean MWCF and the WCE for each number of occupants when the simulation was run 1000 times, with error bars indicating the standard error of the mean. On average, both the MWCF and the WCE increase with the number of simulated occupants, and both values monotonically increase with the number of simulated occupants, and therefore both are potentially suitable for estimating occupant count.

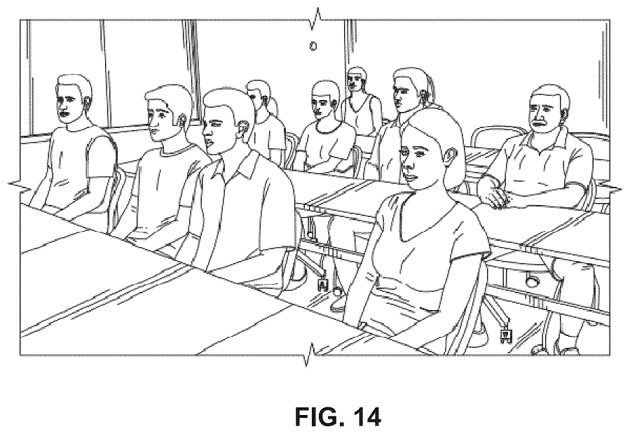

FIG. 14 shows a room filled with occupants for which the subject technology can determine occupancy count and entry/exit counts. The system disclosed in FIG. 1 may be used to determine occupancy count and entry/exit counts. In one embodiment, a 2.4 GHz Doppler radar module with a quadrature receiver (referred to generally as the “RADAR sensor” or “RADAR sensor system”, generates a 2.4 GHz continuous wave signal generated from a signal generator. The signal generator output is split between the local oscillator (LO) and the transmit antenna. The transmit power at the antenna connector may be about 7 dBm. The antenna gain may be approximately 8 dBi, resulting in the effective isotropic radiated power of 15 dBm. A 90° power splitter may be used to split the LO for the quadrature receiver. The backscattered signal from the antenna may be split to send half of the received signal to each mixer. The passive mixer may downconvert the received signal by mixing with the LO, and after filtering and amplification, the AC-coupled quadrature signal may be digitized with a 100 Hz sampling rate and recorded.

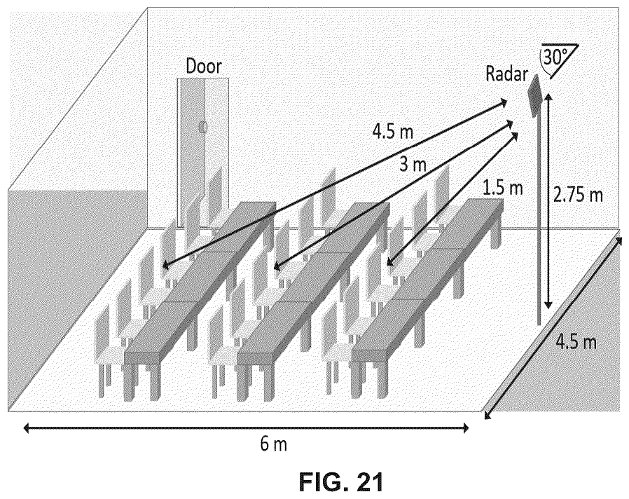

The radar system may be mounted above the floor at the front of a room, to provide full room coverage for occupancy sensing. In one room setup, for purposes of illustration, there are three rows of seats in the room, and the antenna may be angled toward the middle of the room, i.e. the second row, as shown in FIG. 21. In one example scenario, ten occupants enter the room, one by one, every 90 seconds. The room was filled starting with the far side of the first row, with four occupants in the first row, four in the second, and two in the last row. After all ten occupants are seated, they started leaving the room one by one after every 90 seconds. Data may be recorded for about 25 minutes, including 10 individual entry and 10 individual exit events. Since the goal is to detect entry and exit events based on occupant walking patterns, a single channel output may be used to avoid IQ demodulation of signals which included multiple sources with large displacements and varying signal strength.

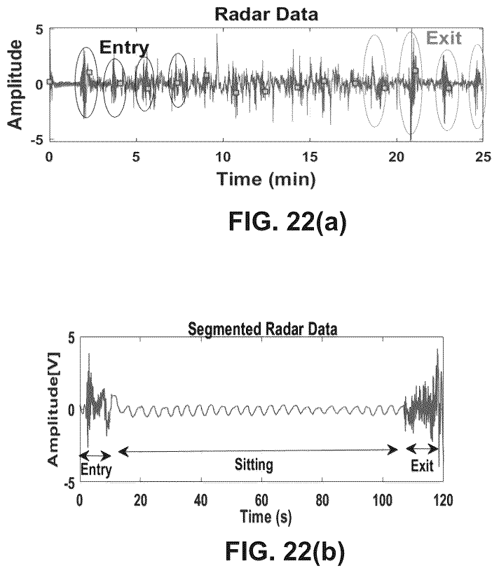

After data acquisition, the signal may be filtered for example, with a 20-Hz cut-off frequency using a low pass filter since physiological and normal walking signals are within the range of 0-20 Hz. FIG. 22(a) illustrates the raw radar output for the whole data set. When an occupant enters the room, there is a large reflection from the subject which increases the amplitude of the signal. As an occupant approaches the radar sensor, signal amplitude initially increases, then decreases until the occupant is sedentary and only breathing is observed. A similar signature is observed during the exit events, however, exit events show a higher amplitude than entry events, likely due to occupants spending more time in the radar field of view as occupants stand up from their seats and start walking towards the door. FIG. 22(b) illustrates the radar output portion of the signal that contains an entry, exit, and sedentary segments. From FIG. 22(b), it is clear that the sedentary segment of the signal shows more periodicity than the exit and entry event signals. In some embodiments, a continuous wavelet transform may be performed with the analytic Morlet wavelet, and the highest amplitude coefficient and the frequency associated with this coefficient, known as MWCF, is identified.

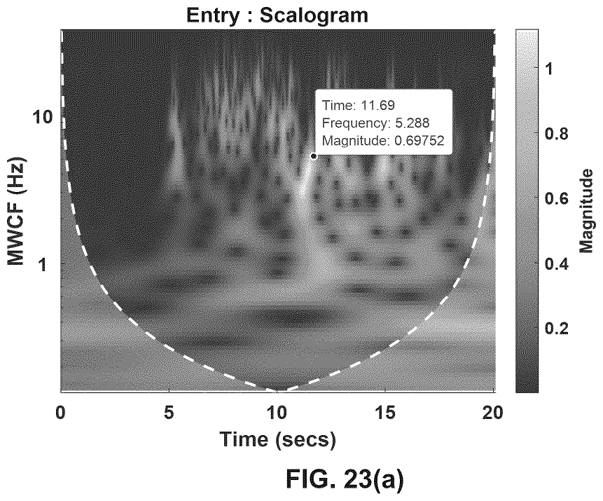

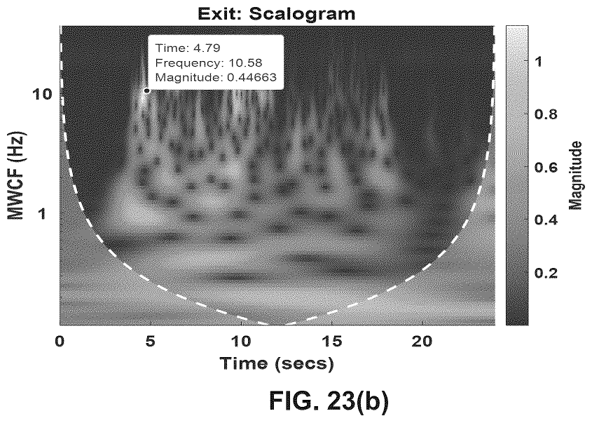

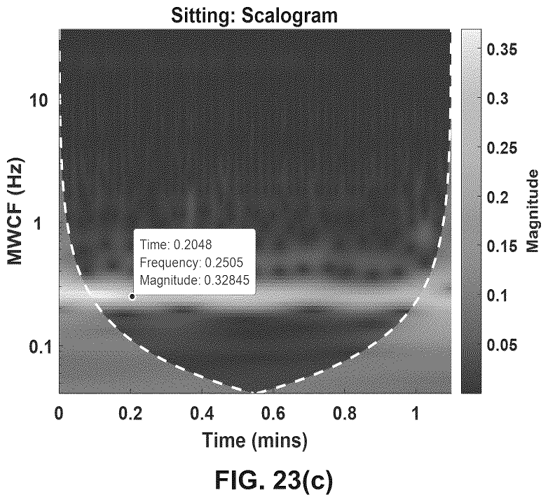

FIGS. 23(a), 23(b), and 23(c) illustrate a time-frequency mapping in the form of a scalogram of the different event (entry, exit, and sitting) episode signals. FIG. 23(a) represents the entry data. FIG. 23(b) represents the exit data. FIG. 23(c) represents the sitting data. From FIGS. 23(a), 23(b), and 23(c) it is clear that the entry event has an MWCF of 5.299 whereas the exit event has a higher MWCF of 10.58. As can be seen from the data, it is quite visible that the MWCF numbers vary significantly for different events. Additionally, in the time-frequency mapping, the pattern of the scalogram is also significantly different. The WCE was calculated for different segments, and it was found that WCE is around 12.29 J for the exit event, 10.07 J for the entry event, and 2.68 J for the sedentary segment. This analysis was repeated for all ten entry and ten exit events to verify the robustness of the extracted entry and exit features. Entry event MWCF varies from 5.3 Hz to 7.23 Hz and WCE varies from 10.06 J to 11.28 J. On the other hand, exit event MWCF varies from 8.71 Hz to 10.58 Hz and WCE varies from 11.58 J to 12.29 J.

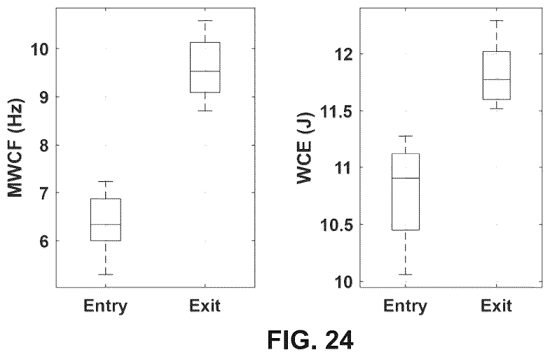

FIG. 24 represents the box plot of the two extracted MWCF and WCE for all ten different segments. From the results, it is clear that the features including MWCF and WCE can be used to distinguish exit and entry events, which can be used for occupant count.

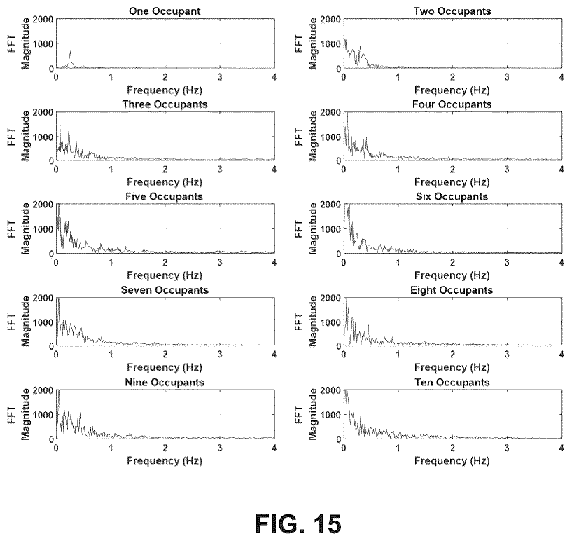

FIG. 15 illustrates the spectra of the linearly demodulated signals for one through ten occupants. As the number of occupants increases, signals include more frequency content above and below breathing frequencies. When there are multiple subjects present in the radar field of view, the radar receives multiple breathing patterns and the mixer non-linearity results in intermodulation products. The constructive and destructive interference of these intermodulation products at different frequencies being effectively summed makes the signals appear aperiodic.

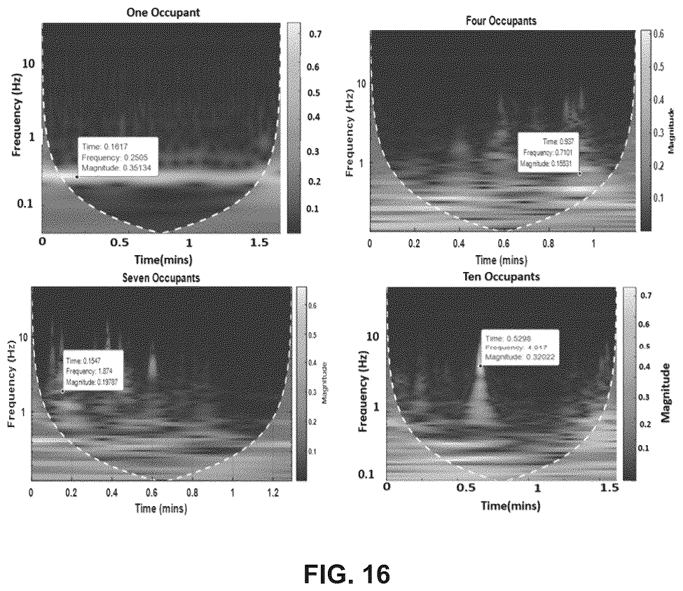

FIG. 16 shows a wavelet scalogram of the subsampled, lowpass filtered baseband signal from experimental data for (a) one occupant, (b) four occupants, (c) seven occupants, and (d) ten occupants. This wavelet transform was performed with the Morlet wavelet with effective support of 16 and a 60-second window of data. The spectrum has more variation in both time and frequency as the number of occupants increases, and the frequency associated with the maximum value in time-frequency space (MWCF) also increases with the number of occupants with values of 0.23 Hz for one occupant, 0.46 Hz for 4 occupants, 0.58 Hz for 7 occupants, and 1.2 Hz for 10 occupants.

The MWCF and the WCE of the segmented 60s window of data was calculated for one to ten occupants, and as the number of participants in the room increased, the MWCF and WCE also increased.

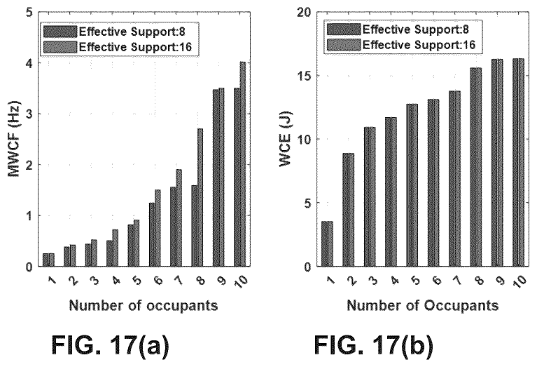

As shown in FIGS. 17(a) and 17(b), a relationship between the MWCF of the segmented portion of the signal and the number of occupants in a room with wavelet effective support of 8 and 16 can be seen. With the increase in the number of occupants there is a more proportional trend in frequency when the effective support function is set to 16 than when it is 8. (right) Relationship between the WCE of the segmented portion of the signal and the number of occupants in a room with wavelet effective support of 8 and 16. No significant difference in this parameter is noted with varied effective support.

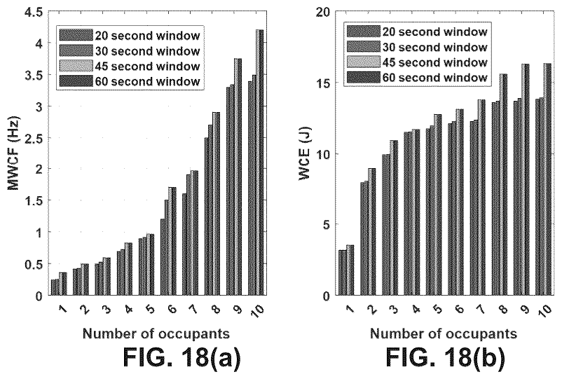

In FIGS. 18(a) and 18(b), a relationship between the MWCF (left) and WCE (right) and occupant count with window length set at 20 seconds, 30 seconds, 45 seconds, and 60 seconds can be seen. The relationship between the MWCF and the number of occupants is more linear with 45 and 60 second windows than it is with 20 and 30 second windows but is monotonically increasing in all cases. The relationship between WCE shows greater differentiation between 6 and 9 occupants with 45 and 60 second windows than with 20 and 30 second windows but is also monotonically increasing in all cases.

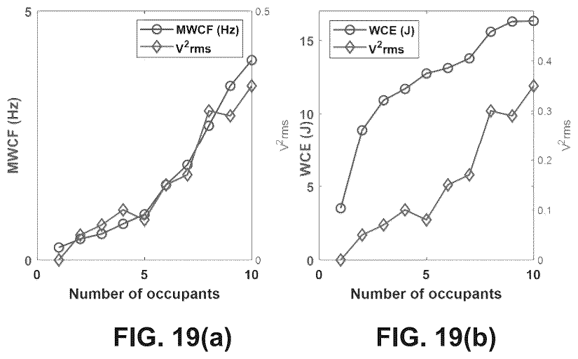

The impact of wavelet effective support was investigated by increasing the effective support from 8 ([−4 4]) to 16 ([−8 8]). When the effective support of the wavelet broadens, the MWCF varies more consistently with the number of occupants, but the WCE does not seem to be significantly impacted by effective support. This increase in variation of the MWCF likely occurs due to Morlet wavelet's center frequency and spectrum breadth increasing with broader effective support. FIGS. 19(a) and 19(b) illustrate the trend between the output parameters and the number of occupants with effective supports of 8 and of 16. With an increase in the number of occupants, there is an increase in the MWCF and the WCE of the segmented signal, regardless of effective support. The increase in the effective support provides better correlation between the MWCF and the number of occupants but does not have a notable impact on the relationship between the WCE and the number of occupants. Effective supports broader than 16 were tested and showed no noticeable change from the results with an effective support of 16 for this data.

Combination of Entry-Exit and Occupant Count

The same sensor described above may be used to detect entry and exit from a room and to estimate the occupant count using the MWCF and or WCE. This combination may be used to overcome the shortcomings of both approaches. Namely, the MWCF/WCE count approaches work when all occupants are stationary, which may only provide intermittent count estimates. The entry/exit sensing detects people entering and exiting the space, and as such can add and subtract to maintain a running count, but this sensor can have errors (from multiple people entering at once, for example) and these errors accumulate over time. If the count is primarily performed by entry/exit sensing, and corrected by the MWCF/WCE occupant count when all occupants are stationary, a correct count can be maintained over time despite the weaknesses of each approach.

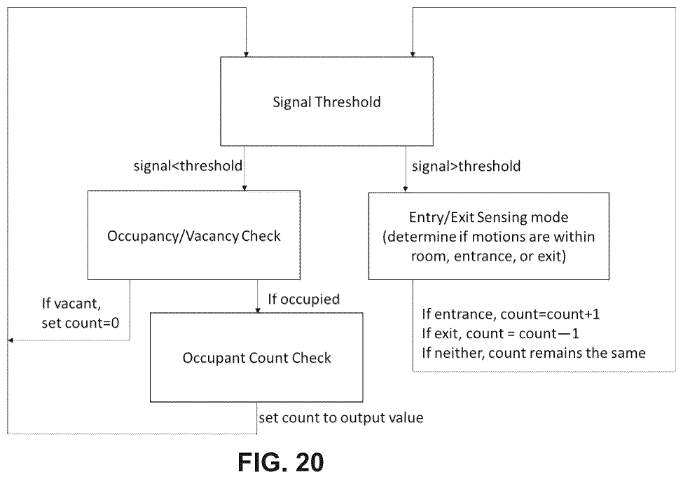

Referring now to FIG. 20, a method of determining room occupancy count is shown according to an embodiment. In some embodiments, a sensor may use threshold sensing to determine whether there is major motion in the room. Depending on whether a signal received has a value above a threshold value or below a threshold value, the method may proceed along one of two different paths. A computer processor or control circuit may perform the steps described below.

For example, if there is no major motion detected (signal is less than threshold value), the sensor may use an occupancy/vacancy sensing mode to check whether the room is occupied. If a processor determines the room is vacant, the processor may set the number of occupants to zero. If the room is occupied, the processor may check occupant count using a time-frequency algorithm. The processor may set the number of occupants to the output value determined using the time frequency algorithm.

When major motion is present, the processor may invoke an entry/exit sensing mode, which may use for example, some combination of MWCF and/or WCE as described above. The processor may analyze the motion signals to determine if any of the occupants are entering the room or exiting the room. If the processor determines a person is entering the room, the processor may increment the occupant count by one. If the processor determines a person is exiting the room, the processor may decrement the occupant count by one.

In some embodiments, if the room is known to be vacant, further checks may not take place until the signal exceeds the threshold, indicating that an occupant has entered the room. This may reduce power consumption by avoiding un-necessary computation.

The subject technology utilizes single antenna continuous wave (CW) Doppler radar for detecting occupant entry and exit events using wavelet analysis, calculating occupant count using wavelet analysis, and of combining the two approaches. The proposed method based on wavelet analysis extracts two important features known as MWCF and WCE which show significant variation for recognizing two events successfully. The proposed system has several potential applications including efficient HVAC management, surveillance, and building evacuation.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

In some embodiments, the computing device controlling the system may operate the processes described above in the general context of computer system executable instructions, such as program modules, being executed by a computer system. The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described above.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processing unit of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A method of determining an occupancy status of a room, comprising:
receiving, by a computer processor, a return signal from a RADAR signal emitted into the room;
converting the return signal into a baseband signal;
dividing, by the computer processor, the baseband signal into windows of time;
shifting, by the computer processor, the windows into an overlapping arrangement wherein some data samples in at least one window are shared by data samples in another window;
processing, by the computer processor, the data samples in the shifted windows;
comparing, by the computer processor, an output value of the processed data samples to a threshold value;
determining, by the computer processor, the room is occupied in the event the output value of the processed data samples is greater than or equal to the threshold value; and
determining, by the computer processor, the room is vacant in the event the output value of the processed data samples is less than the threshold value.

2. The method of claim 1, further comprising removing direct current (DC) offset values from the return signal prior to processing the data samples in the shifted windows.

3. The method of claim 1, wherein processing the data samples in the shifted windows further comprises integrating, by the computer processor, the data samples in the shifted windows using a Riemann integration, and wherein the output value compared to the threshold value is a result of the Riemann integration.

4. The method of claim 3, wherein the threshold value is calculated from data recorded in an empty room as an average value plus 1.5 times a standard deviation.

5. The method of claim 1, wherein processing the data samples in the shifted windows further comprises:
calculating, by the computer processor, an average power in a specified frequency band corresponding to a range of respiration rates; and
comparing, by the computer processor, the average power to the threshold value.

6. The method of claim 5, wherein the average power is an average of an instantaneous power of an in-band signal in the baseband signal.

7. The method of claim 5, wherein threshold value is calculated as the average power plus one standard deviation from data recorded when the room is empty.

8. A computer program product for determining an occupancy status of a room, the computer program product comprising a non-transitory computer readable storage medium having computer readable program code embodied therewith, the computer readable program code being configured, when executed by a processor, to:
receive a return signal from a RADAR signal emitted into the room;
convert the return signal into a baseband signal;
divide, by the computer processor, the baseband signal into windows of time;
shift the windows into an overlapping arrangement wherein some data samples in at least one window are shared by data samples in another window;
process the data samples in the shifted windows;
compare an output value of the processed data samples to a threshold value;
determine the room is occupied in the event the output value of the processed data samples is greater than or equal to the threshold value; and
determine the room is vacant in the event the output value of the processed data samples is less than the threshold value.

9. The computer program product of claim 8, further comprising computer readable code configured to remove direct current (DC) offset values from the return signal prior to processing the data samples in the shifted windows.

10. The computer program product of claim 8, wherein processing the data samples in the shifted windows further comprises integrating, by the processor, the data samples in the shifted windows using a Riemann integration, and wherein the output value compared to the threshold value is a result of the Riemann integration.

11. The computer program product of claim 10, wherein the threshold value is calculated from data recorded in an empty room as an average value plus 1.5 times a standard deviation.

12. The computer program product of claim 8, wherein processing the data samples in the shifted windows further comprises:
calculating, by the processor, an average power in a specified frequency band corresponding to a range of respiration rates; and
comparing, by the processor, the average power to the threshold value.

13. The computer program product of claim 12, wherein the average power is an average of an instantaneous power of an in-band signal in the baseband signal.

14. The computer program product of claim 12, wherein threshold value is calculated as the average power plus one standard deviation from data recorded when the room is empty.

15. A system for determining an occupancy status of a room, comprising:
a RADAR transceiver; and
a computing device coupled to the RADAR transceiver, wherein the computing device includes a processor configured to:
receive a return signal from a RADAR signal emitted into the room;
convert the return signal into a baseband signal;
divide, by the computer processor, the baseband signal into windows of time;
shift the windows into an overlapping arrangement wherein some data samples in at least one window are shared by data samples in another window;
process the data samples in the shifted windows;
compare an output value of the processed data samples to a threshold value;
determine the room is occupied in the event the output value of the processed data samples is greater than or equal to the threshold value; and
determine the room is vacant in the event the output value of the processed data samples is less than the threshold value.

16. The system of claim 15, wherein processing the data samples in the shifted windows further comprises integrating, by the processor, the data samples in the shifted windows using a Riemann integration, and wherein the output value compared to the threshold value is a result of the Riemann integration.

17. The system of claim 16, wherein the threshold value is calculated from data recorded in an empty room as an average value plus 1.5 times a standard deviation.

18. The system of claim 15, wherein processing the data samples in the shifted windows further comprises:
calculating, by the processor, an average power in a specified frequency band corresponding to a range of respiration rates; and
comparing, by the processor, the average power to the threshold value.

19. The system of claim 18, wherein the average power is an average of an instantaneous power of an in-band signal in the baseband signal.

20. The system of claim 18, wherein threshold value is calculated as the average power plus one standard deviation from data recorded when the room is empty.
